(19) United States
(12) Patent Application Publication
(10) Pub. No.: US 2010/0128118 A1
(43) Pub. Date: May 27, 2010

(54) IDENTIFICATION OF VISUAL FIXATIONS IN A VIDEO STREAM

(75) Inventors: Colin SWINDELLS, Victoria (CA); Mario ENRIQUEZ, Richmond (CA); Ricardo PEDROSA, Vancouver (CA)

Correspondence Address: FASKEN MARTINEAU DUMOULIN LLP, 2900 - 550 Burrard Street, VANCOUVER, BC, V6C 0A3, CA

(73) Assignee: LOCARNA SYSTEMS, INC., Victoria (CA)

(21) Appl. No.: 12/626,510

(22) Filed: Nov. 25, 2009

Related U.S. Application Data
(60) Provisional application No. 61/118,361, filed on Nov. 26, 2008.

(51) Int. Cl. H04N 7/18; H04N 5/225

(52) U.S. Cl. 348/78; 348/169; 348/E07.085; 348/E05.024

(57) ABSTRACT

A method for identifying a visual fixation in an eye tracking video including: locating eye gaze coordinates in a first frame of a video, defining a spatial region surrounding the eye gaze coordinates, identifying and marking consecutive video frames having an eye gaze coordinate location within the spatial region. Wherein the consecutive video frames span at least a minimum fixation time and define a visual fixation.

### TECHNICAL FIELD

The present invention relates to eye tracking, in particular, identification of visual fixations in a video stream produced by an eye tracking device.

### BACKGROUND

Eye tracking devices for determining where a subject is looking at a given time are well known in the art. Such devices typically include a first video camera for capturing a scene and a second video camera for capturing eye movement of the subject. The video streams are processed to produce a single video, which shows the scene and includes a pointer that identifies where the subject is looking at any given time.

A subject will focus on features in a scene that are of particular interest. The location and analysis of such features is the basis for the majority of eye tracking applications. For example, in marketing applications, a company may use eye tracking at a focus group in order to gage consumer interest in a new product line; in medical studies, an evaluation of emotional states during a psychotherapy regime may be performed by analyzing eye movement patterns; in sport applications, performance may be enhanced by determining where athletes are focusing at particular times during an athletic event; in reading applications, visual attention to particular text, figures, or tables may be compared; in military applications, it is possible to determine if a solider notices a particular threatening enemy combatant or equipment, as well as the spatial locations of friendly people, weapons, supplies or communications equipment; in surgical training, it is possible to compare the eye patterns of expert vs. novice medics in an effort to validate the effectiveness of training regimes and better communicate best practices; and, in safety or quality control inspections of facilities such as power plants or equipment such as aircraft, visual fixation patterns may serve as a record.

Identification of features of interest in a video is typically achieved by performing a frame-by-frame review of the video and manually recording regions of interest and noteworthy events in a notebook or in a spreadsheet. The process is both tedious and time consuming. The time required to record features of interest in a single 60 minute video often takes between four and ten hours and may even exceed ten hours. It is therefore desirable to reduce the amount of time spent identifying features of interest in a video.

### SUMMARY

There is provided herein a method for identifying a visual fixation in a video stored in a computer memory, the method including: performing, on a computer, a search to locate eye gaze coordinates in a first frame of the video, performing, on the computer, a calculation to define a spatial region surrounding the eye gaze coordinates performing, on the computer, a comparison to determine if consecutive video frames have an eye gaze coordinate location within the spatial region, electronically marking the consecutive video frames in the video, wherein the consecutive video frames span at least a minimum fixation time and define the visual fixation.

There is further provided herein an apparatus for identifying a visual fixation in a video stored in a computer memory, the apparatus including: an eye camera for obtaining eye video, a scene camera for obtaining scene video, a computer processor for merging the eye video and the scene video and identifying and marking visual fixations to provide a visual fixation-marked video, the visual fixation-marked video being stored in a computer memory; and a user interface for displaying the visual fixation-marked video and receiving tag input, the tag input being stored in the computer memory and being associated with the visual fixations.

There is still further provided herein a method for identifying a visual fixation in a video stream, the method including: locating eye gaze coordinates in a first frame of a video, defining a spatial region surrounding the eye gaze coordinates and identifying and marking consecutive video frames having an eye gaze coordinate location within the spatial region; wherein the consecutive video frames span at least a minimum fixation time and define a visual fixation.

### DRAWINGS

The following figures set forth embodiments of the invention in which like reference numerals denote like parts. Embodiments of the invention are illustrated by way of example and not by way of limitation in the accompanying figures.

FIG. 1 is a schematic diagram of an eye tracking system according to an embodiment of the present invention;

FIG. 2 is a flowchart depicting a method for identifying visual fixations in an eye tracking video according to an embodiment;

FIG. 3 is a flowchart depicting a method for associating a tag with a visual fixation in an eye tracking video according to an embodiment; and

FIG. 4 is an example of a user interface for use with the method of FIG. 3.

### DETAILED DESCRIPTION OF EMBODIMENTS

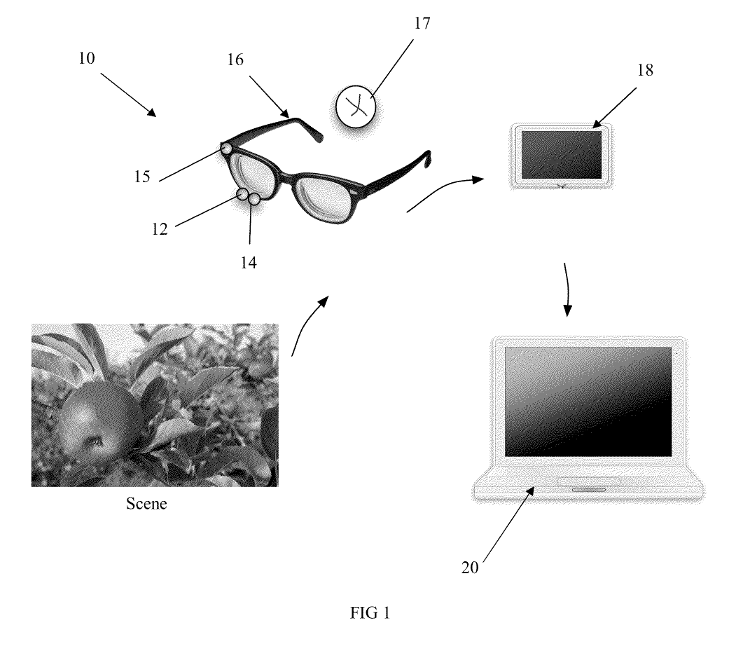

Referring to FIG. 1, an eye tracking system 10 is generally shown. The eye tracking system 10 includes a scene camera 12 and an eye camera 14 mounted on a wearable accessory 16, such as a pair of eye glasses, for example. The scene camera 12 captures video frames of an object in a scene, such as the apple of FIG. 1, for example. Objects may be static or moving and include: articles, animals and people, for example.

At the same time as the scene camera 12 captures video frames of objects, the eye camera 14 captures video frames of a subject's eye. Video frames containing surrounding facial features or markers 17 may also be captured by the eye camera 14.

Such markers are useful for correcting movement of the wearable accessory relative to the subject's eye.

It will be appreciated by a person skilled in the art that the eye tracking system 10 may further include a microphone 15 for capturing sounds from the environment. In addition, the eye tracking system 10 may include more than one scene camera 12 and more than one eye camera 14.

Video captured using the scene camera 12 and the eye camera 14 is stored on a portable media storage device 18, which communicates with the cameras 12, 14 via a cable (not shown) or a wireless connection. A computer 20 is provided in communication with the portable media storage device 18 to receive the captured video therefrom. The computer 20 merges the scene video and the eye video to produce a single eye tracking video including eye gaze coordinates that are generally provided on each video frame. The merged scene video and eye video is stored in a computer memory. Techniques for merging scene video and eye video are well known in the art and any suitable merging process may be used.

Communication between the computer 20 and the portable media storage device 18 occurs via a cable (not shown) that is selectively connected therebetween. Alternatively, communication may occur via a wireless connection; or, rather than being a separate unit, the media storage device 18 may be incorporated into the computer 20. The computer 20 includes a processor (not shown) for executing software that is stored in a computer memory or other computer readable medium. The software includes computer code for performing visual fixation identification and tag association methods described herein.

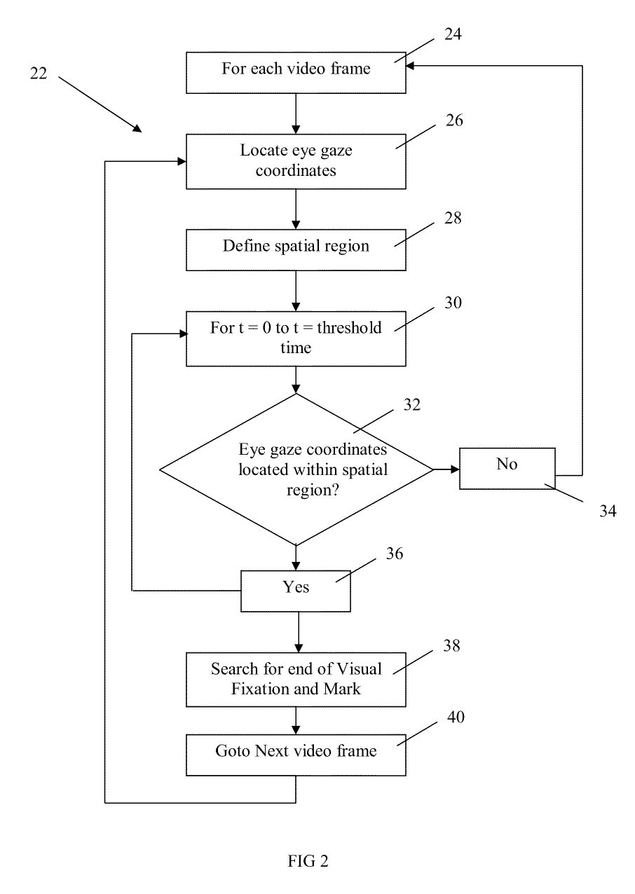

Referring to FIG. 2, a method for identifying visual fixations in a video stream 22 is generally shown. Visual fixations are generally defined as eye gaze coordinates that are maintained within a spatial region for at least a defined time period. More specifically, a visual fixation is defined as eye gaze coordinates that are maintained at a 2-D position [x, y] in a video stream within defined spatial tolerances (i.e., [x±δₓ, y±δ_{y}]) for a minimum time threshold. The minimum time threshold is typically between 10 and 2000 milliseconds, however, suitable threshold times outside of this range may also be used. The spatial region may be any geometric shape such as a circle, ellipse, square or rectangle, for example. In one embodiment, the spatial region is a circle having a diameter of 10 pixels. In another embodiment, the spatial region is defined with respect to a user's field of view and includes a diameter that is between 0.01° and 180° of the user's field of view. In still another embodiment, the spatial region is centered on the eye gaze coordinates.

For each frame of an eye tracking video that is stored in computer memory, the eye gaze coordinates are first determined and a corresponding spatial region is defined, as indicated at steps 24 through 28. Then, for the subsequent video frame, the eye gaze coordinates are compared to the spatial region in order to determine if they are located therein, as indicated at steps 30 and 32. If the eye gaze coordinates are located in the spatial region, as indicated at step 36, the eye gaze coordinates of the next frame within the minimum threshold time are compared to the spatial region. If the eye gaze coordinates are located in the spatial region for every frame of the minimum threshold time, then the video is searched to locate the last frame of the visual fixation and the visual fixation is marked, as indicated at step 38. The visual fixation is marked on the video file by including a ‘start’ marker at the beginning of the fixation and an ‘end’ marker at the end of the fixation. Intermediate markers for each video frame within the fixation may also be marked. Once the visual fixation has been marked, the process continues at step 26 to locate the eye gaze fixation in the first video frame following the visual fixation, as indicated as step 40. Alternatively, if the eye gaze coordinates are not located in the subsequent video frame, as indicated at step 34, the process continues at step 24 with the next video frame.

By marking the visual fixations, it is possible for a user to quickly navigate through a video and view the visual fixations. The method of FIG. 2 is more efficient than prior art processing techniques and, therefore, allows eye tracking methods to be applied more efficiently and effectively in many different applications.

The video, eye gaze, and visual fixation data may be viewed or analyzed in real-time as the data is collected, or afterwards, from computer memory. Furthermore, these visual fixations may be either static or dynamic, i.e. the term “visual fixation” includes visual attention of the user's eye gaze towards both static and moving objects.

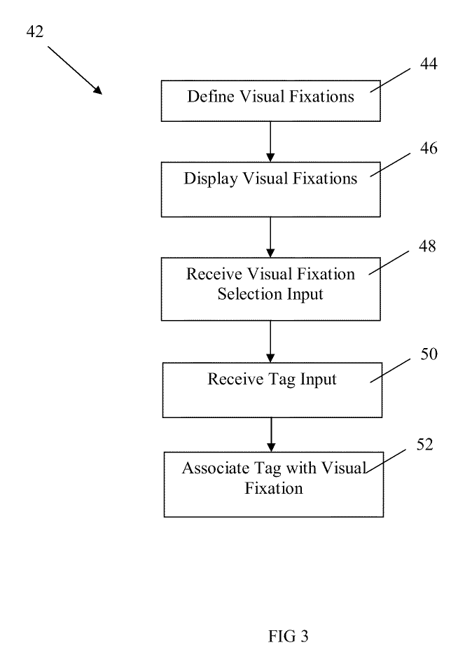

For videos having extended length it is desirable to associate a meaningful tag with the visual fixations so that a user does not need to remember numbers or time codes associated with the visual fixations. Referring to FIG. 3, a method for associating a tag with a visual fixation in an eye tracking video 42 is generally shown. At step 44, visual fixations are defined. The visual fixations may be defined by using the method of FIG. 2 or another method for defining visual fixations, such as a manual method, for example. At step 46, the visual fixations are displayed so that they may be viewed by a user. At step 48, visual fixation selection input is received from the user. At step 50, tag input is received from the user. At step 52, the tag is associated with the selected visual fixation.

In one embodiment, the tag is associated by using a comma separated value (CSV) file that stores a timestamp of the current visual fixation frame number, a timestamp of the ending visual fixation frame number, the current starting visual fixation frame number i.e., the first frame of the visual fixation sequence, the current ending visual fixation frame number i.e., last frame of the visual fixation sequence, visual fixation spatial co-ordinates and time period values, and a textual tag. Other methods for associating the tag to the visual fixation may alternatively be used.

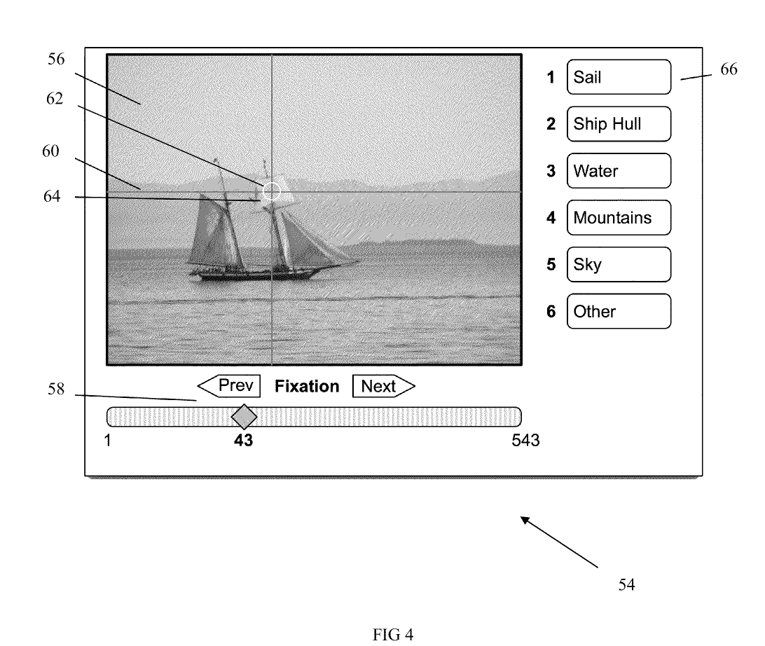

Referring to FIG. 4, an example of a user interface 54 for viewing and associating visual fixation markers with user defined tags is generally shown. Video footage is rendered for display by a computer processor and played on a window 56. A navigation bar 58 is located below the window 56. A first visual indicator 60, such as a cross-hair, for example, is located at the eye gaze coordinates of the video frame in window 56. A second visual indicator 62, such as a circle, for example, overlaps the first visual indicator 60 at visual fixation locations. The navigation bar 58 allows a user to navigate between the different fixations in the video. The navigation bar 58 extends between the first visual fixation and the last visual fixation. In this example, there are 543 fixations. The user moves the slider of the navigation bar to select a new active visual fixation to display and process. The user may also navigate between visual fixations by selecting the “prey” and “next” buttons. The background of the navigation bar 58 changes color in order to indicate to the user visual fixations that already have associated tags, such associated text tags are delineated using a technique such as highlighting, for example.

As shown, the user of the eye tracking device 10 fixated on one of the sails of the ship. The sail 64 is identified as a visual fixation by the circle 62. The video loops continuously between the first frame of the visual fixation and the last frame of the visual fixation until a user selects a different fixation to view. Both the objects in the video and the eye tracking markers move throughout a video clip because, in this example, the ship is does not maintain the exact same position and rotation throughout a series of video frames.

Text tags 66 are provided adjacent to the window 56. Each text tag 66 has a unique name that is associated with features of interest in the video. The text tag names are modifiable by the user and are useful for providing meaning to visual fixations. In order to associate the text tags 66 with a visual fixation, the user selects the tag while the fixation loop is playing on the screen 56. For example, in FIG. 3, the user is able to associate visual fixation number “43” with the text tag “sail” by selecting the tag, while visual fixation number “43” is playing in window 56. If a text tag is associated with the visual fixation that is displayed in window 56, its text tag border is outlined with a bolder, thicker line. The set of text tags are stored in a text file so that the user is able to modify the text file in order to include new tag names.

In one embodiment, a pattern of visual fixations is detected. Once a video has been analyzed to locate the visual fixations, patterns are identified based on user-defined search criteria. For example, a “price comparison uncertainty” pattern may be defined by three successive visual fixations in which first and third visual fixations are directed toward a first price tag and a second visual fixation is directed toward a second price tag. A tag may then be associated with the “price comparison uncertainty” pattern. A time in which the pattern occurs would also be defined by the user. In the example provided, a time of between 1 ms and 30 minutes may be appropriate.

It will be appreciated by a person skilled in the art that the spatial tolerances and time threshold are adjustable for each different eye tracking video. For example, for videos that include many small objects that may be of interest, the tolerance is reduced, whereas for videos that include only a few large objects, the tolerance is increased.

It will further be appreciated by a person skilled in the art that the method of FIG. 2 may be applied directly to scene video and eye video as they are being merged into a single video.

Specific embodiments have been shown and described herein. However, modifications and variations may occur to those skilled in the art. All such modifications and variations are believed to be within the scope and sphere of the present invention.

1. A method for identifying a visual fixation in a video stored in a computer memory, said method comprising:
performing, on a computer, a search to locate eye gaze coordinates in a first frame of said video;
performing, on said computer, a calculation to define a spatial region surrounding said eye gaze coordinates;
performing, on said computer, a comparison to determine if consecutive video frames have an eye gaze coordinate location within said spatial region;
electronically marking said consecutive video frames in said video;
wherein said consecutive video frames span at least a minimum fixation time and define said visual fixation.

2. A method as claimed in claim 1, wherein said spatial region is a geometric shape.

3. A method as claimed in claim 2, wherein said geometric shape is selected from the group consisting of: circle, ellipse, square and rectangle.

4. A method as claimed in claim 1, wherein said spatial region has a diameter that corresponds to between 0.01° and 180° of a field of view of a user.

5. A method as claimed in claim 1, wherein said minimum fixation time is between 10 and 2000 milliseconds.

6. A method as claimed in claim 1, wherein a pattern of visual fixations is identified, said pattern comprising at least two visual fixations occurring in succession.

7. A method as claimed in claim 1, comprising:
rendering said visual fixation for display on a display screen;
receiving tag input from a user interface; and
associating said tag input with said visual fixation by storing said tag input in computer memory.

7. An apparatus for identifying a visual fixation in a video stored in a computer memory, said apparatus comprising:
an eye camera for obtaining eye video;
a scene camera for obtaining scene video;
a computer processor for merging said eye video and said scene video and identifying and marking visual fixations to provide a visual fixation-marked video, said visual fixation-marked video being stored in a computer memory; and
a user interface for displaying said visual fixation-marked video and receiving tag input, said tag input being stored in said computer memory and being associated with said visual fixations.

8. An apparatus as claimed in claim 7, wherein said eye camera and said scene camera are mounted on a wearable accessory.

9. A method for identifying a visual fixation in a video, said method comprising:
locating eye gaze coordinates in a first frame of said video;
defining a spatial region surrounding said eye gaze coordinates; and
identifying and marking consecutive video frames having an eye gaze coordinate location within said spatial region;
wherein said consecutive video frames span at least a minimum fixation time and define a visual fixation.

10. A computer readable medium comprising instructions executable on a processor for implementing the method of claim 8.
